(19) United States
(12) Patent Application Publication
(10) Pub. No.: US 2023/0122684 A1
(43) Pub. Date: Apr. 20, 2023

(54) SYSTEMS AND METHODS FOR AUTOMATICALLY SOURCING CORPORA OF TRAINING AND TESTING DATA SAMPLES FOR TRAINING AND TESTING A MACHINE LEARNING MODEL

(71) Applicant: DryvIQ, Inc., Ann Arbor, MI (US)

(72) Inventors: Stefan Larson, Dexter, MI (US); Steve Woodward, Canton, MI (US); Shuan Becker, Canton, MI (US)

(21) Appl. No.: 17/968,929

(22) Filed: Oct. 19, 2022

Related U.S. Application Data
(60) Provisional application No. 63/257,376, filed on Oct. 19, 2021.

(51) Int. Cl. G06V 10/774

(52) U.S. Cl. CPC G06V 10/7753; G06V 10/7747

(57) ABSTRACT

A system and method of curating machine learning training data for improving a predictive accuracy of a machine learning model includes sourcing training data samples based on seeding instructions; returning a corpus of unlabeled training data samples based on a search of data repositories; assigning a distinct classification labels to each of the training data samples of the corpus; computing efficacy metrics for an in-scope corpus of labeled training data samples derived from a subset of training data samples of the corpus that have been assigned one of the plurality of distinct classification labels, wherein the efficacy metrics identify whether the in-scope corpus of labeled training data samples is suitable for training a target machine learning model; and routing the in-scope corpus of labeled training data samples based on the efficacy metrics.

### CROSS-REFERENCE TO RELATED APPLICATIONS

This application claims the benefit of U.S. Provisional Application No. 63/257,376, filed on 19 Oct. 2021, which is incorporated in its entirety by this reference.

### TECHNICAL FIELD

This invention relates generally to the data handling and data governance fields, and more specifically to a new and useful systems and methods for machine learning-based classifications of data items for sensitivity-informed handling and governance in the data handling and data governance fields.

### BACKGROUND

Evolving data security and data compliance risks are some of the factors that may be driving entities to take different approaches to handling their data including reorganizing their data from decentralized and often complex storage systems to centralized, cloud-based storage architectures. Additionally, misclassified digital items and unstructured digital items may further complicate attempts to successfully govern and/or manage digital items throughout any type of storage system.

In traditional on-premises data storage and nonintegrated or disjointed storage architectures, identifying data files and content that may include potentially sensitive information and further managing permissions for controlling access to files and content having high security threat and compliance risks can be especially difficult.

Thus, there are needs in the data handling and data governance fields to create improved systems and methods for intelligently handling data and providing intuitive data governance and controls that curtail the several data security and data compliance risks posed by legacy data storage and management architectures.

The embodiments of the present application described herein provide technical solutions that address, at least the needs described above.

### BRIEF SUMMARY OF THE INVENTION(S)

In one embodiment, a method of curating machine learning training data for improving a predictive accuracy of a machine learning model includes sourcing, via a training data search engine, training data samples based on seeding instructions, wherein the seeding instructions include a data sample search query that includes a data sample category parameter; returning a corpus of unlabeled training data samples based on using the data sample search query to execute a search of one or more data repositories; assigning one of a plurality of distinct classification labels to each of the training data samples of the corpus of unlabeled training data samples; computing one or more efficacy metrics for an in-scope corpus of labeled training data samples derived from a subset of training data samples of the corpus of unlabeled training data samples that have been assigned one or more of the plurality of distinct classification labels, wherein the one or more efficacy metrics identify whether the in-scope corpus of labeled training data samples is suitable for training a target machine learning model; and routing, based on the one or more efficacy metrics, the in-scope corpus of labeled training data samples to one of a machine learning training stage for training the target machine learning model and a remedial training data curation stage for adapting the in-scope corpus for training the target machine learning model.

In one embodiment, computing the one or more efficacy metrics for the in-scope corpus of labeled training data samples includes computing a sparseness metric value for one or more regions of an n-dimensional mapping of embedding values of the training data samples of the in-scope corpus; the method further includes identifying one or more training features of the in-scope corpus that are under-represented based on the sparseness metric value for the one or more regions failing to satisfy a minimum sparseness value threshold, wherein routing the in-scope corpus of labeled training data samples to the remedial training data curation stage is based on the sparseness metric value for the one or more regions; and creating re-seeding parameters based on identifying the one or more training features that are under-represented.

In one embodiment, the method further includes converting the seeding instructions to re-seeding instructions based on revising the data sample search query with the re-seeding parameters, wherein the re-seeding parameters augments the data sample category parameter with a data sample feature category parameter that informs a directed search for training data samples satisfying the data sample feature category parameter; and executing a new sourcing, via the training data search engine, for new training data samples based on the re-seeding instructions; and adapting the in-scope corpus of labeled training data samples with at least part of the new training data samples, wherein routing the in-scope corpus to the machine learning training stage is based on new sparseness metric values computed for the one or more regions satisfying the minimum sparseness value threshold.

In one embodiment, computing the one or more efficacy metrics for the in-scope corpus of labeled training data samples includes computing a density metric value for one or more regions of an n-dimensional mapping of embedding values of the training data samples of the in-scope corpus; the method further includes identifying one or more training features of the in-scope corpus that are over-represented based on the density metric value for the one or more regions satisfy a maximum density value threshold, wherein routing the in-scope corpus of labeled training data samples to the remedial training data curation stage is based on the density metric value for the one or more regions; and creating re-seeding parameters based on identifying the one or more training features that are over-represented.

In one embodiment, the method further includes converting the seeding instructions to re-seeding instructions based on revising the data sample search query with the re-seeding parameters, wherein the re-seeding parameters augments the data sample category parameter with a data sample feature category parameter that informs a directed search for training data samples that do not satisfy the data sample feature category parameter; and executing a new sourcing, via the training data search engine, for new training data samples based on the re-seeding instructions; and adapting the in-scope corpus of labeled training data samples with at least part of the new training data samples, wherein routing the in-scope corpus to the machine learning training stage is based on the adaptation of the in-scope corpus of labeled training data samples.

In one embodiment, computing the one or more efficacy metrics for the in-scope corpus of labeled training data samples includes computing one or more feature gaps of the in-scope corpus of labeled training data samples; the method further includes identifying one or more training features of the in-scope corpus that are not represented among the labeled training data samples based on the one or more feature gaps, wherein routing the in-scope corpus of labeled training data samples to the remedial training data curation stage is based on identifying the one or more training features of the in-scope corpus that are not represented; and creating re-seeding parameters based on the one or more training features that are not represented.

In one embodiment, the method further includes converting the seeding instructions to re-seeding instructions based on revising the data sample search query with the re-seeding parameters, wherein the re-seeding parameters augments the data sample category parameter with a data sample feature category parameter that informs a directed search for training data samples that satisfy the data sample feature category parameter; and executing a new sourcing, via the training data search engine, for new training data samples based on the re-seeding instructions; and adapting the in-scope corpus of labeled training data samples with at least part of the new training data samples, wherein routing the in-scope corpus to the machine learning training stage is based on the adaptation of the in-scope corpus of labeled training data samples.

In one embodiment, returning the corpus of unlabeled training data samples based on using the data sample search query further includes: executing a training data sample generation request to one or more data sample generation sources configured to create a plurality of training data samples of the corpus of unlabeled training data samples.

In one embodiment, the method further includes defining the in-scope corpus of data samples based on grouping together training data samples having a classification label that satisfies the data sample category parameter of the data sample search query.

In one embodiment, the method further includes defining an out-of-scope corpus of data samples based on grouping together training data samples having a classification label that does not satisfy the data sample category parameter of the data sample search query.

In one embodiment, the method further includes defining a training corpus of labeled training data samples based on grouping together a sampling of the in-scope corpus of data samples and a sampling of the out-of-scope corpus of data samples.

In one embodiment, a method of curating machine learning training data for training a machine learning model includes sourcing, via a training data sourcing engine, training data samples based on seeding instructions, wherein the seeding instructions include one or more target data samples; returning a corpus of unlabeled training data samples based on using the one or more target data samples to initialize a machine learning-based generation of each of the unlabeled training data samples; assigning one of a plurality of distinct classification labels to each training data samples of the corpus of unlabeled training data samples; computing one or more efficacy metrics for an in-scope corpus of labeled training data samples derived from a subset of the corpus of unlabeled training data samples that have been assigned one or more of the plurality of distinct classification labels, wherein the one or more efficacy metrics identify whether the in-scope corpus of labeled training data samples is suitable for training a target machine learning model; and routing the in-scope corpus of labeled training data samples to: a machine learning training stage for training the target machine learning model based on the one or more efficacy metrics satisfying one or more efficacy metric thresholds, or a remedial training data curation stage for adapting the in-scope corpus for training the target machine learning model based on the one or more efficacy metrics failing to satisfy the one or more efficacy metric thresholds.

In one embodiment, the training data sourcing engine is in operable communication with one or more generative adversarial networks, the one or more generative adversarial network being trained to generate new document samples based on the one or more target data samples including one or more document samples, and the in-scope corpus of labeled training data samples includes a plurality of labeled document samples for training the target machine learning model.

In one embodiment, the training data sourcing engine is in operable communication with one or more generative adversarial networks, the one or more generative adversarial network being trained to generate new image samples based on the one or more target data samples including one or more image samples, and the in-scope corpus of labeled training data samples includes a plurality of labeled image samples for training the target machine learning model.

In one embodiment, a method of curating machine learning training data for a machine learning model includes sourcing, via a web-scale search engine, training data samples based on seeding instructions, wherein the seeding instructions include a data sample search query that includes a data sample category parameter; returning a corpus of unlabeled training data samples based on using the data sample search query to execute a search of one or more web-based data repositories; converting the corpus of unlabeled training data samples to a corpus of labeled training data samples by assigning one of a plurality of distinct classification labels to each of the unlabeled training data samples; identifying a corpus deficiency of the corpus of labeled training data samples based on an assessment of one or more feature attributes of the labeled training data samples, wherein the corpus deficiency relates to a defect or lacking in one or more expected features of the labeled training data samples having a likelihood of failing to satisfy a training efficacy threshold for the target machine learning model, when trained using the corpus of labeled training data samples; computing one or more feature-based category parameters based on the corpus deficiency, wherein the one or more feature-based category parameters, if executed in a new search, likely ameliorate the corpus deficiency; adapting the seeding instructions based on the one or more feature-based category parameters; executing a new sourcing, via the training data sourcing engine, for new training data samples based on the adapted seeding instructions updating the corpus of labeled training data samples with at least part of the new training data samples; and initializing a training of the target machine learning model using the corpus of labeled training data samples, as updated, if the corpus deficiency is ameliorated.

In one embodiment, identifying the corpus deficiency including computing one or more efficacy metrics including one or more feature density metrics, one or more feature sparseness metrics, or one or more feature gaps of the corpus of labeled training data samples.

In one embodiment, the corpus deficiency includes an over-representation deficiency indicating that that one or more features of the labeled training data samples has a density value that satisfies or exceeds a maximum feature density threshold.

In one embodiment, the corpus deficiency includes an under-representation deficiency indicating that that one or more features of the labeled training data samples has a density value that does not satisfy a minimum feature density threshold.

In one embodiment, the corpus deficiency includes a feature gap deficiency indicating that that one or more expected features the corpus of the labeled training data samples is lacking.

### BRIEF DESCRIPTION OF THE FIGURES

FIG. 1 illustrates a schematic representation of a system 100 in accordance with one or more embodiments of the present application;

FIG. 2 illustrates an example method 200 in accordance with one or more embodiments of the present application;

FIG. 3 illustrates a schematic representation of a first implementation of one or more sub-components of the system 100 in accordance with one or more embodiments of the present application;

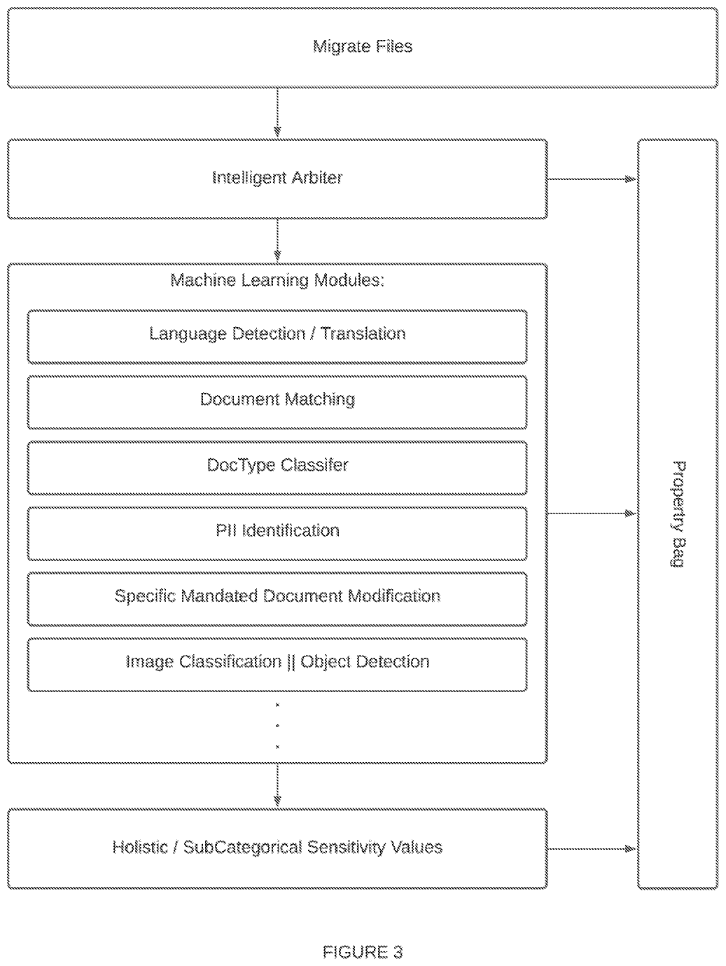

FIG. 4 illustrates a schematic representation of a second implementation of one or more sub-components of the system 100 in accordance with one or more embodiments of the present application;

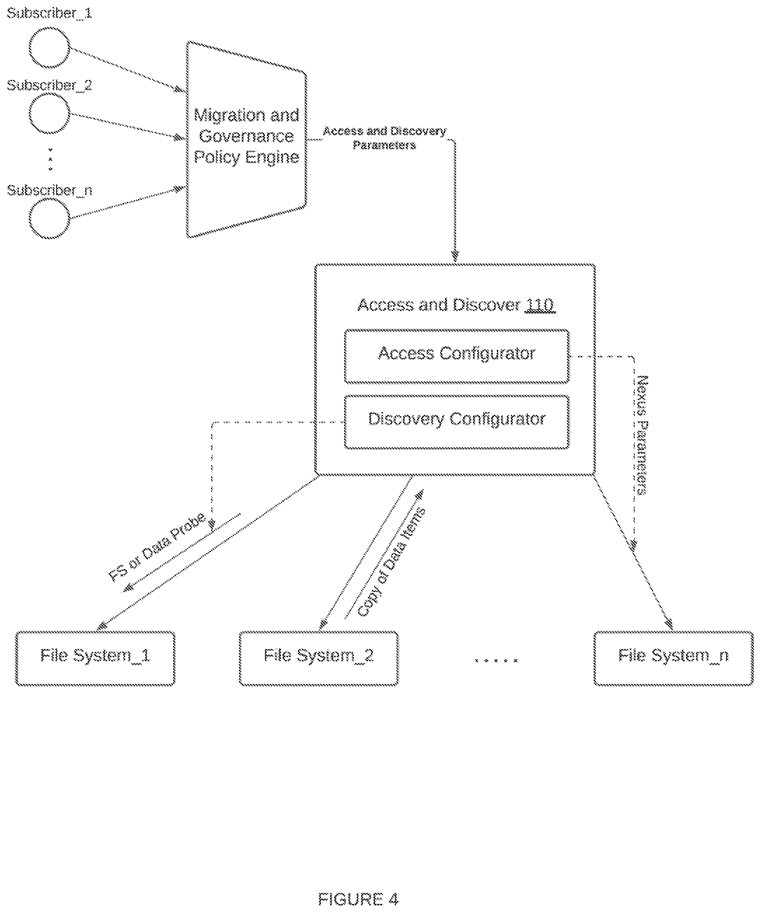

FIG. 5 illustrates a schematic representation of an example for generating action tasks for a data item in accordance with one or more embodiments of the present application;

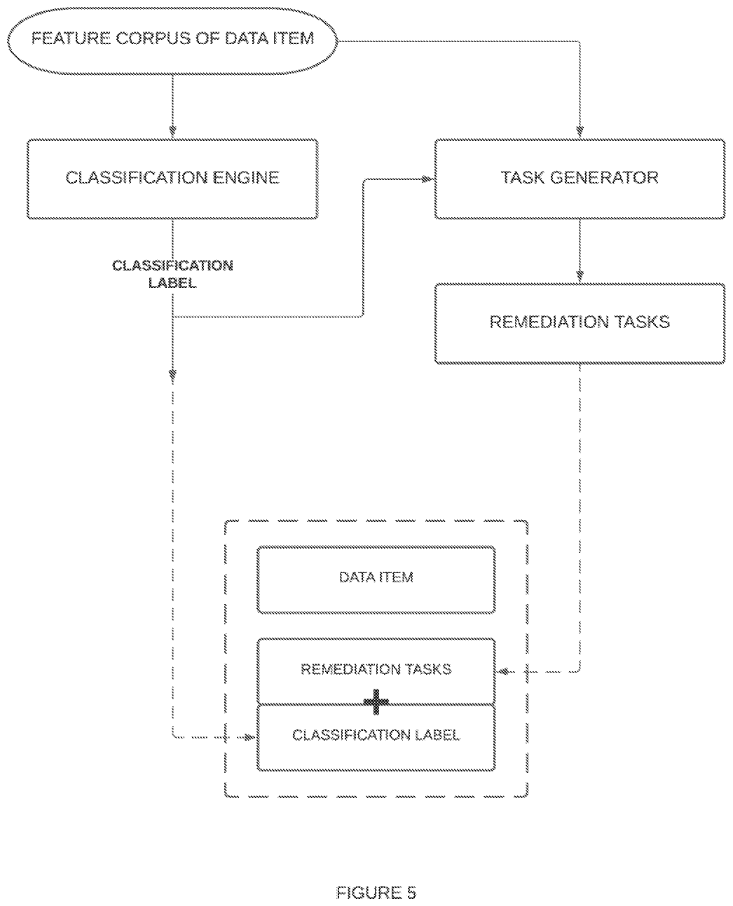

FIG. 6 illustrates a schematic representation of an example for implementing a remediation stage for handling a data item in accordance with one or more embodiments of the present application;

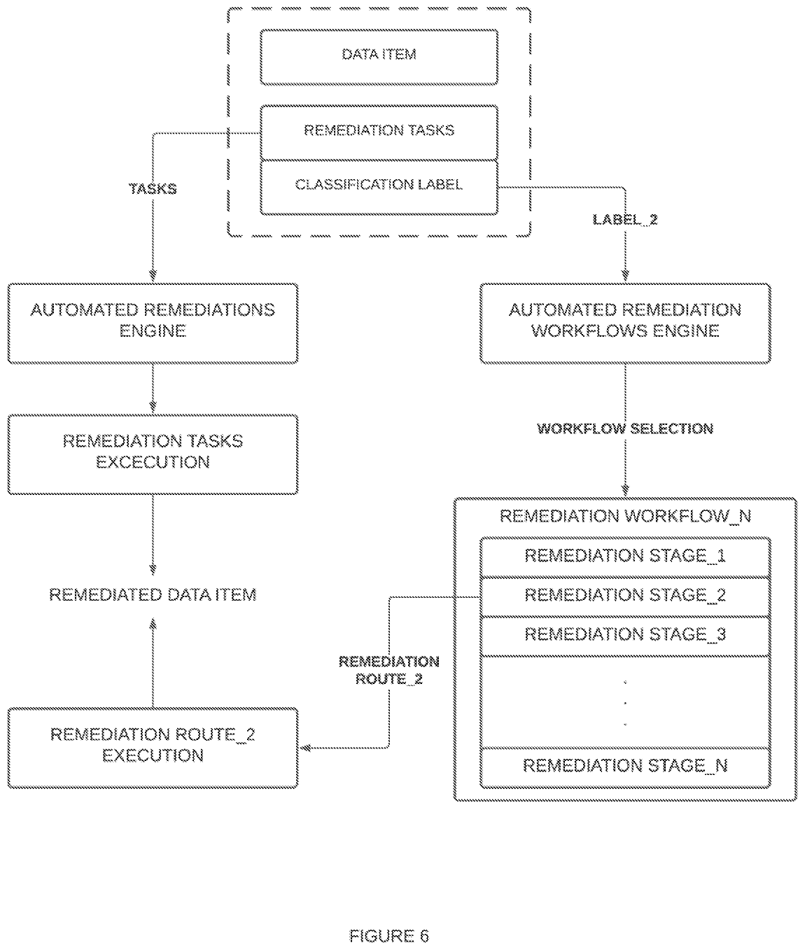

FIG. 7 illustrates a schematic representation of an example of implementing a sensitivity evaluation stage for handling a data item in accordance with one or more embodiments of the present application;

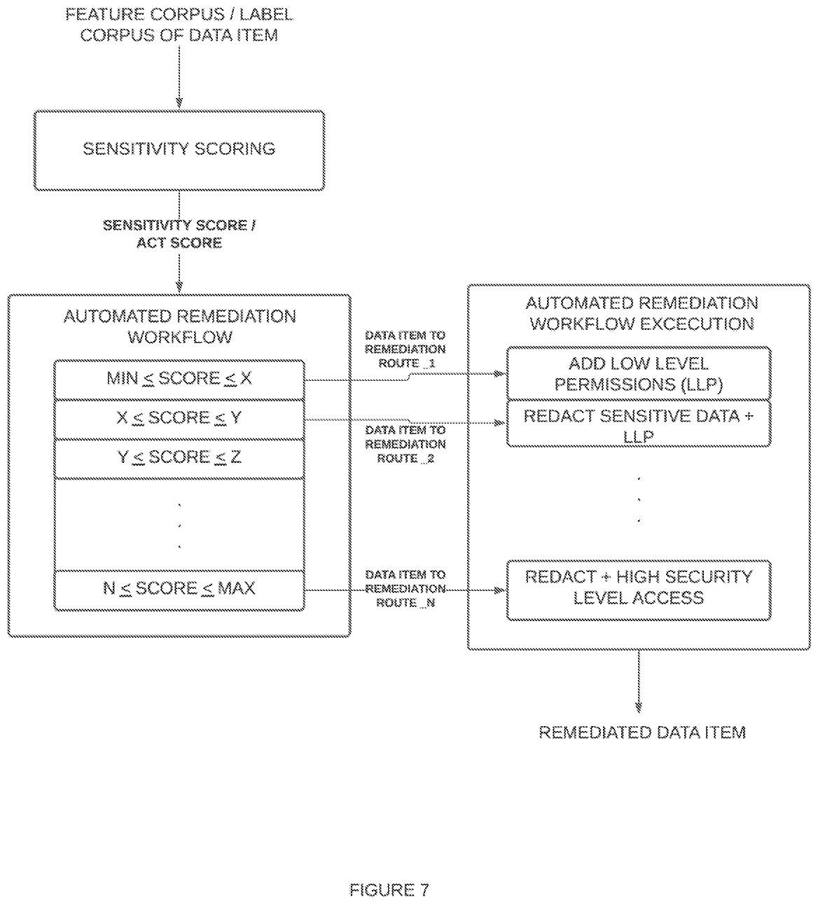

FIG. 8 illustrates a schematic representation of an example of a sample sourcing subsystem of the system 100 in accordance with one or more embodiments of the present application.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Intelligent Content Handling and Content Governance

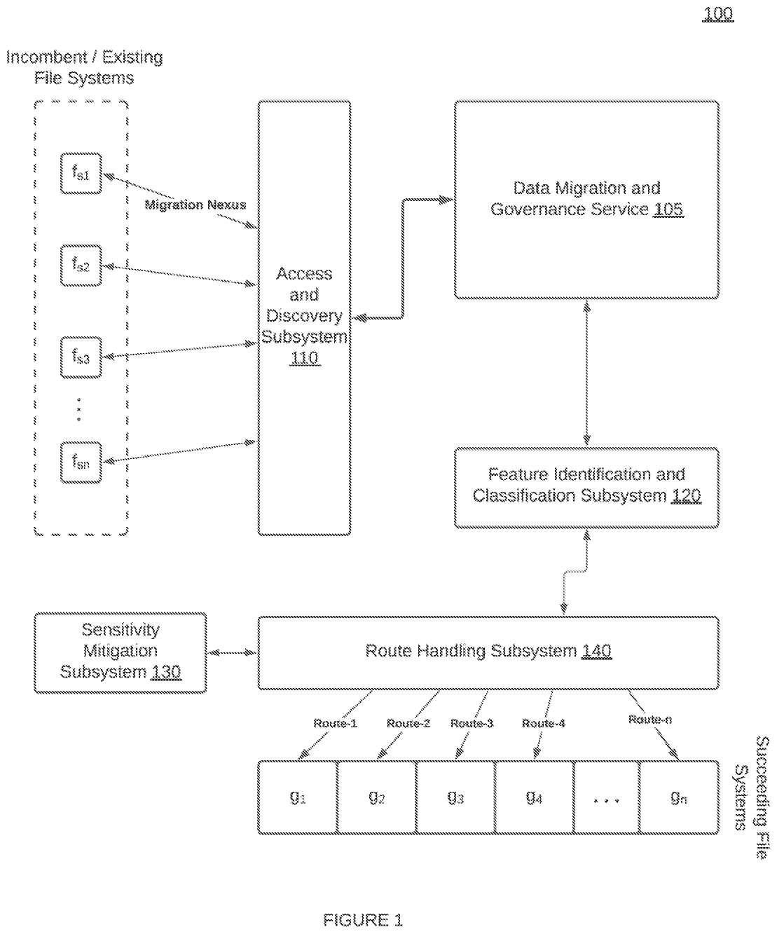

As shown in FIG. 1, a system 100 for intelligent data handling and data governance includes a data handling and governance service 105, an access and discovery subsystem 110, a feature identification and classification subsystem 120, a sensitivity mitigation subsystem 130, and a content route handling subsystem 140, as described in U.S. Patent Application No. 63/215,203, which is incorporated herein in its entirety by this reference. The system 100 may sometimes be referred to herein as an intelligent data handling and data governance system 100 or simply the data handling system 100.

### 1.05 Intelligent Content Access+Content Handling Subsystem

The data handling and governance service 105, sometimes referred to herein as the “data handling service 105” may be implemented by a distributed network of computers and may be in operable and control communication with each of the subsystems of the system 100. That is, the data handling service 105 may include a centralized controlling computer server(s) and associated computing systems that encourages and/or controls the intelligent data handling, data classification, and data governance operations of each of the subsystems 110-140.

In one or more embodiments, the data handling service 105 may function to implement a data handling and data governance application programming interface (API) that enables programmatic communication and control between the data handling system 100 and the one or more sub-services therein and APIs of the one or more subscribers to the data handling service 105 of the data handling system 100.

### 1.1 Content Access+Discovery Subsystem

The access and discovery subsystem 110, which may be sometimes referred to herein as the “discovery subsystem” or “discovery subservice”, preferably functions to enable one or more electronic connections between the data handling system 100 and one or more external systems of one or more subscribers to the data handling service 105. The discovery subsystem may include one or more access modules that may function to establish or create content communication channels, which are sometimes referred to as “migration nexus” or “data handling nexus”, between the data handling system 100 and subscriber systems. In one or more embodiments, the data handling nexus may include any suitable medium and/or method of transmitting digital items between at least two devices including, but not limited to, a service bus, a digital communication channel or line, and/or the like.

The discovery subsystem 100 may additionally or alternatively include one or more discovery submodules that perform one or more content discovery actions and/or functions for identifying existing file and content systems within a computing architecture of a subscriber.

### 1.2 Content Feature Identification and Classification Subsystem

The feature identification and classification subsystem 120, which may sometimes be referred to herein as a “classification subsystem”, preferably functions to compute one or more classification labels for each target file or target content being migrated and/or handled by the data handling system 100.

In one or more embodiments, the classification subsystem 100 includes a machine learning module or subsystem that may be intelligently configured to predict various classifications for each target file or target document including, but not limited to, identifying a document type, identifying sensitive information, identifying a document's language (e.g., via a language detection model), identifying objects or images, identifying document form values, and/or the like. In such embodiments, the classification subsystem 100 may include a plurality of distinct machine learning-based classification submodules, which may be outlined herein below in the method 200.

Additionally, or alternatively, in some embodiments, the classification subsystem 100 may include one or more content classification modules that include extensible classification heuristics derived from one or more of subscriber-defined content policy and/or data handling service-derived content policy.

Additionally, or alternatively, the classification subsystem 100 may implement one or more ensembles of trained machine learning models. The one or more ensembles of machine learning models may employ any suitable machine learning including one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), adversarial learning, and any other suitable learning style. Each module of the plurality can implement any one or more of: a machine learning classifier (e.g., LayoutLM, LayoutLM-v2, LayoutLM-v3, DocFormer, TILT, UDoc, and the like that may use a combination of text input, image input, and page layout as feature inputs for producing classification inferences), computer vision model, convolutional neural network (e.g., ResNet), visual transformer model (e.g., ViT), document transformer model (e.g., DiT or document image transformer), object detection model (e.g., R-CNN, YOLO, etc.), regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a semantic image segmentation model, an image instance segmentation model, a panoptic segmentation model, a keypoint detection model, a person segmentation model, an image captioning model, a 3D reconstruction model, a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, density-based spatial clustering of applications with noise (DBSCAN), expectation maximization, etc.), a bidirectional encoder representation from transformers (BERT) for masked language model tasks and next sentence prediction tasks and the like, variations of BERT (i.e., ULMFiT, XLM UDify, MT-DNN, SpanBERT, RoBERTa, XLNet, ERNIE, KnowBERT, VideoBERT, ERNIE BERT-wwm, MobileBERT, TinyBERT, GPT, GPT-2, GPT-3, GPT-4 (and all subsequent iterations), ELMo, content2Vec, and the like), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. Each processing portion of the system 100 can additionally or alternatively leverage: a probabilistic module, heuristic module, deterministic module, or any other suitable module leveraging any other suitable computation method, machine learning method or combination thereof. However, any suitable machine learning approach can otherwise be incorporated in the system 100. Further, any suitable model (e.g., machine learning, non-machine learning, etc.) may be implemented in the various systems and/or methods described herein.

### 1.3 Content Sensitivity Mitigation Subsystem

The sensitivity mitigation subsystem 130 preferably functions to perform one or more automated actions that reduces a sensitivity of a target file or target content or otherwise, improves a security of a target file or target content for protecting sensitive or secure content/information. Sensitive information or data preferably relate to data that must be guarded from unauthorized access and unwarranted disclosure to maintain the information security of an individual or an organization. In one or more embodiments, sensitive information may be defined based on subscriber information security policy or file system policy. In some embodiments, sensitive information may be defined based on data handling service-defined file system policy.

The sensitivity mitigation subsystem 130 may include a plurality of distinct automated sensitivity mitigation workflows or the like to which a target file or target content may be intelligently routed based on classification data.

### 1.4 Automated Document Identification Module

The content route handling subsystem 140 preferably functions to intelligently route each target file or target content based on classification inferences or predictions of the classification subsystem 120. In some embodiments, a succeeding or new file system of a subscriber may include a predetermined configuration for ingesting and/or storing target digital items and content. In such embodiments, the content route handling subsystem 140 may be configured based on the storage parameters and/or configurations of the succeeding file system(s) and perform a routing of target files and target content to appropriate regions or partitions of the succeeding file system(s).

Additionally, or alternatively, the content route handling subsystem 140 may function to route distinct target files and/or target content to the sensitivity mitigation subsystem 130 based on the one or more features discovered and classifications of the classification subsystem 120.

### 1.5 Automated Training Sample Sourcing Subsystem

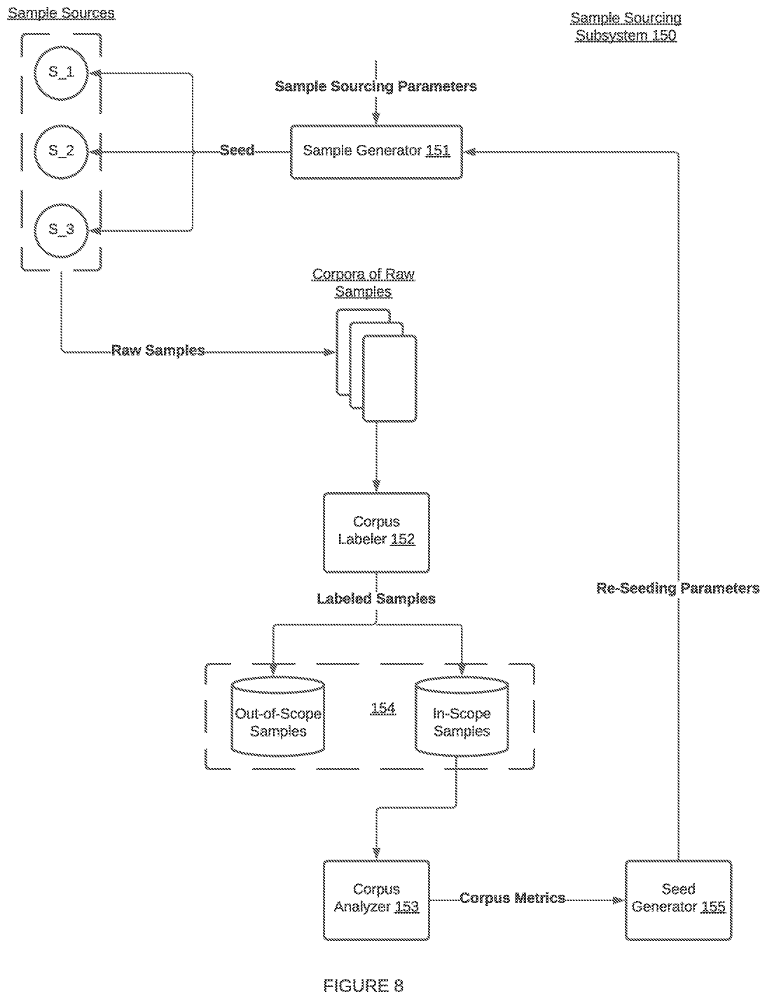

The automated training sample sourcing subsystem 150 preferably includes a document-image generator interface 151, a corpus annotations module 152, a training corpus analyzer (module) 153, one or more training sample repositories 154, and/or a seed/re-seed generator 155, as shown by way of example in FIG. 8. In a preferred embodiment, the automated training sample sourcing subsystem 150 may function to source document and/or image training data samples via a document-image generator 151 that may be in operable communication with a plurality of sources of training data samples. In a preferred embodiment, the document-image generator 151 may be seeded with sourcing parameters that may be used in generating requests for document and/or image training data sources to various of the plurality of sources of training data samples.

It shall be recognized that the document-image generator interface 151 may be interchangeably referred to herein as an image generator interface and may be additionally configured for sourcing corpora of image samples. It shall also be recognized that while in the description provided herein reference is preferably made to a sourcing and handling of document samples, the sourcing and handling of image samples should also be implied in each instance when not expressly described or mentioned.

The corpus annotations module 152 preferably functions to ingest a corpus of unlabeled document samples or image samples and compute classification labels and/or annotations for each distinct sample within a target corpus of document samples.

The training corpus analyzer (module) 153 preferably functions to evaluate one or more attributes of a corpus of document samples or image samples being sourced for training a target machine learning model. In one or more embodiments, the training corpus analyzer 153 may be configured to automatically compute one or more corpus metrics that indicate a likely level of efficacy of a target corpus of training data samples for potentially training a target machine learning model on a specific task.

The one or more training sample repositories 154 may function to store the corpus of labeled document samples. In a preferred embodiment, the one or more training sample repositories may be bifurcated into two distinct repositories in which a first repository may function to store in-scope labeled document samples and a second repository may function to store out-of-scope labeled document samples.

The seed/re-seed generator 155 may function to generate one or more document sourcing parameters for sourcing one or more corpora of document samples from a plurality of distinct sources of document samples. In some embodiments, the re-seed generator 155 may function to generate re-seeding sourcing parameters based on an evaluate of a pending corpus of document samples. That is, calculated corpus metrics and/or identified corpus deficiencies may inform a derivation of one or more seed sourcing parameters for a continued creation or build out of one or more corpus of document or image samples.

### 2. Method for Automated Sourcing of Training Samples and Building Effective Corpora of Training Data

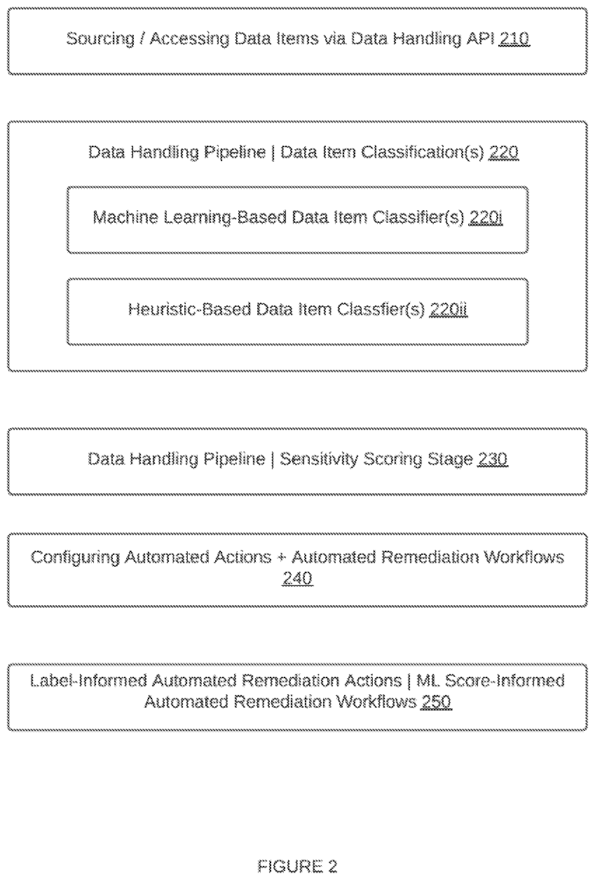

As shown in FIG. 2, a method 200 for automated sourcing of document or image samples and automated creation of effective corpora of machine learning training data includes identifying sample sourcing seed parameters S205, generating one or more sample sourcing parameters S210, labeling a corpora of raw document or image samples S220, computing one or more metrics for the corpora of document or image samples S230, identifying a routing for the one or more corpora of document or image samples S240, and generating one or more re-seeding document sample or image sourcing parameters S250.

### 2.05 Seeding Generation

In one or more embodiments, S205 may function to identify a document or image sample sourcing seed parameters, which may be interchangeably referred to herein as a “sample seed”. The sample seed, in one or more embodiments, may include a collection of one or more sourcing parameters, one or more sourcing constraints, and one or more sourcing terms that may be used as criteria for locating and retrieving relevant document or image samples and/or for creating document or image samples via one or more document or image data sources. In a non-limiting example, a sample seed may comprise a sample search query that includes distinct search terms and/or search parameters (e.g., search constraints) for sourcing document or image samples.

It shall be noted that throughout the description herein references to document samples preferably includes or implies a reference to image samples for the sake of simplicity.

In a first implementation, a sample seed may be automatically generated based on identifying or setting a machine learning task to a sample seed generator (e.g., seed generator 155) or module. In this first implementation, the sample seed generator may be specifically programmed to automatically create one or more proposals of samples seeds for document sample generation or sourcing when the sample seed generator is provided an input of a distinct machine learning task or machine learning objective (e.g., training one or more task-specific machine learning models). That is, an input of a distinct and/or specific machine learning task, such as resume document identification or classification, may inform and further cause the sample seed generator to create one or more sample seed proposals for sourcing the proper training data samples for training a machine learning model to perform the specified machine learning task.

In a variant of the first implementation, a seed sample may be automatically generated based on an input of a document sample or an image sample. In this variant, S210 may function to process and/or read the example document sample and derive one or more seed samples for sourcing like-documents or images based on the processing. Accordingly, S210 may function to generate one or more sample sourcing parameters based on an evaluation of a target document or image sample and may function to derive a target category or any suitable sourcing parameters of the seed sample including, but not limited to, a document category (e.g., Category: resume), a document sub-category (e.g., sub-category: marketing resume), document file type (e.g., file type: pdf), and/or the like.

It shall be recognized that in some embodiments the seed sample generator or module may be operably integrated with the document-image generator. Alternatively, in some embodiments, the seed sample generator may be independent of the document-image generator and may, additionally, or alternatively, be in operable communication with a corpus analyzer for receiving sourcing parameters for generating one or more re-seeding proposals.

In a second implementation, a seed sample and/or seeding parameters may be derived, in part, by one or more experts or engineers in training data sourcing. In this second implementation, seed sample or re-seeding samples created by an engineer may be partly informed by program or system-derived sample sourcing parameters. In one example, a system or a service implementing the method 200 may function to identify one or more sample sourcing parameters that may address one or more deficiencies and/or gaps in an existing corpus of training data or in corpus of training data that may be in generation, but not yet completed.

### 2.1 Document-Image Generator|Sourcing Corpora of Unlabeled Samples

S210, which includes sourcing one or more corpora of unlabeled document samples, may function to generate one or more corpora of raw or unlabeled samples of document samples from one or more external data sources based on intelligently setting seeding parameters for a search, a discovery, a retrieval, and/or a generation of or more corpora of document data. In a preferred embodiment, S210 may function to implement a document-image generator that includes a document or image sourcing interface that may be in operable communication connection with a plurality of distinct external sources for retrieving and/or creating document or image samples. Via the document-image sourcing interface, in such embodiments, S210 may function to enable an input and/or an enumeration of any suitable document sourcing parameters identifying one or more attributes or properties of suitable document samples including, but not limited to, file name, file type, file location, industry, business type, color, shape, image type, any suitable image or document attribute, and/or the like. Additionally, or alternatively, S210 may function to enable an input of exclusion parameters for excluding document samples having one or more properties defined by the exclusion parameter.

Document-Image Sample Sourcing and Creation Engine(s)

In one or more embodiments, S210 may function to implement a document-image generator that selectively communicates seed sample parameters to one or more of a plurality of distinct external sources of document data. That is, in such embodiments, the document-image generator may have programmatic, web, and/or Internet-based access to each of the plurality of distinct external sources of document data and may selectively provide a request for document data to a subset or all the distinct external sources based on the criteria or sourcing parameters of the request.

In a first implementation, S210 may function to implement a document-image generator via web-scale search engine (e.g., Google, Bing, Duckduckgo, etc.). In this first implementation, the document-image generator may be operably integrated with the web-scale search engine such that document sourcing parameters received via an interface of the document-image generator may be passed directly as input to the web-scale search engine.

In this first implementation, document sourcing parameters comprises a search query in which the search logic of web-scale search engine or the like may be used to perform a search of any publicly available repository of document data.

In one or more embodiments, document sourcing parameters may include parameters and/or constraints that may function to delimit the document search space and consequently, the attributes of the types of documents that may be returned based on the search. In a non-limiting example, document sourcing parameters may include one or more categorical parameters including a likely name of a file type or sample type (e.g., resume) or an industrial category, a sub-category parameter that may hierarchically fall under a categorical parameter (e.g., business resume or marketing as a sub-category of an industrial category or the like), a file type (e.g., pdf, png, rtf, etc.), and/or the like.

In a variant of this first implementation, S210 may function to implement a document-image generator that sources document samples via one or more opensource APIs for generating or providing corpora of document samples. For instance, S210 may function to create one or more API calls based on document sourcing parameters for sourcing document samples and/or image data samples.

In a second implementation, S210 may function to implement a document-image generator via one or more search engines or visual search engines interfacing with database-scale or private corpora of documents. In this second implementation, the document-image generator may be given access permissions to one or more of a plurality of private corpora of documents. In one example, a subscriber of a service implementing the method 200 may function to provide programmatic or similar access to one or more corpora of documents or the like stored in private databases of the subscriber.

In a third implementation, S210 may function to implement a document-image generator that interfaces with one or more document crowdsourcing platform. In this third implementation, S210 may function to transmit the document sourcing parameters that may cause the one or more crowdsourcing platforms to either create one or more corpora of document samples and/or find/retrieve document samples consistent with the document sourcing parameters. In a variation of this third implementation, S210 may function to implement a document-image generator interfacing with a synthetic data generation service. In such embodiments, S210 may function to transmit the document sourcing parameters to a synthetic data generation service causing the synthetic data generation service to create one or more corpora of document samples and/or image samples based on the document sourcing parameters.

In a fourth implementation, S210 may function to implement a document-image generator that interface with one or more generative deep learning models, such as generative adversarial networks or a text-to-image model (e.g., DALL-E and/or DALL-E 2, a transformer language model derived from GPT-3) for producing one or more corpora of document samples or image samples. In this fourth implementation, document sourcing parameters may include one or more document seed samples or one or more image seed samples from a generative deep learning model may use as model input for learning and subsequently, generating new document samples or new image samples based on learning derived from the document or image seed samples.

It shall be recognized that S210 may function to implement a document-image generator that may interface with any combination of the above implementations for intelligently sourcing document samples and/or image samples. In one or more embodiments, S210 may function to selectively transmit document sourcing parameters to one or more of the plurality of external document sourcing endpoints preferably on the basis of the property attributes desired for the one or more corpora of document samples or image samples. For example, in some embodiments, an optimal corpus configuration may include set proportions for synthetic data samples and real data samples for training a machine learning model and thus, in such embodiments, S210 may function to provide at least a first data source for generating synthetic document samples and a second data source for providing real data samples. Accordingly, it shall be recognized that S210 may function to enable an input of corpus proportions that may inform the selection of the one or more data sources for sourcing document samples and/or image samples for a given corpus. In another example, when it may be determined that one or more public or privately available sources of document or image data may fail to satisfy a corpus size threshold (e.g., a minimum number of desired document or image samples), S210 may automatically switch to a different external source for document or image data, such as a synthetic data sample generating source.

Additionally, or alternatively, S210 may function to collect the one or more corpora of document samples for each of the plurality of distinct external sources of document data and intelligently store each distinct corpus based on one or more of a source of the document data and the distinct document sourcing parameters for the document sample. Accordingly, S210 may function to generate sourcing metadata and/or document sample identifiers for tracking each distinct corpus of document samples.

### 2.2 Sample Labeling|Sample Annotations

S220, which includes labeling a corpora of raw document samples or raw image samples, may function to implement a labeling stage for intelligently labeling one or more corpora of unlabeled document samples. In one or more embodiments, the labeling stage may include providing and/or appending a classification label to each distinct document sample. Additionally, or alternatively, the labeling stage may include providing and/or appending one or more annotations, which may include a classification label, to each distinct document samples that may describe one or more additional properties of each document sample beyond its general classification label.

It shall be noted that, in some embodiments, S220 may function to implement the labeling stage to compute or determine multiple distinct classification labels for each distinct document sample. In such embodiments, S210 may function to determine a category classification and one or more sub-category classification labels for one or more distinct document samples of the corpora of raw document samples. For example, S210 may function to determine a first category classification label of “resume” for a document samples and further determine a second sub-category classification of “marketing” thereby classifying the document sample, in the aggregate, as a marketing resume or the like.

In a first implementation, S220 may function to automatically label each document sample of the raw corpora of document samples. In this first implementation, S220 may function to implement one or more automatic labeling techniques that may include, but should not be limited to, pattern-matching based labeling, clustering-based labeling, and/or using a labeling layer having human-in-the-loop labeling/annotations.

In one embodiment, S220 may function to perform automatic labeling using a pattern-matching technique that includes a comparison analysis between a subject document sample and an archetypal document sample. In such embodiment, the archetypal document sample may be a prototypical example of a suitable document sample that satisfies a target category/target classification label and that may be suitable for training a target machine learning model on a desired task. In a comparison analysis between the subject document sample and the archetypal document sample, S220 may function to compute a percentage match value or a probability of match value indicating a degree to which the subject document sample matches the archetypal document sample. In a preferred embodiment, S220 may function to evaluate the percentage match value or the like against a document matching threshold and if the percentage match value for the subject document sample satisfies or exceeds the document matching threshold, S220 may function to assign and/or annotate the subject document sample with a corresponding classification label of the archetypal document sample.

In yet another embodiment, S220 may function to perform automatic labeling using one or more clustering techniques. In some embodiments, the one or more clustering techniques may include using an unsupervised machine learning model that may function to cluster document samples based on relative relation. In one implementation, S220 may function to perform a clustering of a corpus of document samples to identify document samples that may potentially have a degree of similarity that likely indicates that the document samples may be in a same or similar category.

In this one implementation, the clustering technique may include clustering documents with a threshold number of matching terms or, in the case of image samples, matching features (e.g., shape, color, position, etc.). Once clustered, S220 may function to sample the cluster for one or more document samples to identify a potential classification category for the cluster. Accordingly, once a classification category is determined, S220 may function to apply a classification label corresponding to the classification category to each distinct document sample in the cluster.

In a variation of this one implementation, the clustering technique may include clustering documents using an unsupervised machine learning model or clustering algorithm. In such implementation, S220 may function to compute an embedding value or vector representation for each document sample of a corpus of raw document samples and provide the computed vectors of the corpus of raw document samples as input to the unsupervised model, which may then compute one or more clusters of document sample vectors. In at least some embodiments, example ways to compute the embedding vector(s) may include, but should not be limited to, weighted or unweighted bag-of-words representation (e.g., TF-IDF weighted bag-of-words vectors), using a pre-trained model like or similar to BERT (and variants thereof), LayoutLM (and variants thereof, e.g., LayoutLM-v2, LayoutLM-v3), document or sentence embedding models (e.g., Doc2Vec, SBERT, and the like), aggregation of word embeddings (e.g., averaging Word2Vec or GloVe word embeddings), and/or the like. Similar to the term-matching based clustering, S220 may function to sample one or more document samples from each cluster to determine a classification category for each distinct cluster and apply the corresponding classification label to each document sample defining a given cluster.

In a further variation, in an analysis of the one or more clusters of document sample vectors output by the unsupervised machine learning model, S220 may function to compute a centroid for each of the one or more clusters. In such further variation, S220 may function to apply a predetermined radius from the centroid of a cluster and re-define the cluster with only the document sample vectors within the radius from the centroid while potentially excluding vectors beyond the radius from the cluster. In such embodiment, document samples having a representative vector within the redefined cluster may be given a same classification label. Document sample vectors beyond a radius of a target cluster may be distinctly evaluated in a separate classification process (e.g., human-in-the-loop) since it is likely that document sample vectors beyond the threshold and/or that may exist on a fringe of a cluster may have a lower probability of matching a classification category as the vectors within the radius (i.e., vectors in the re-defined cluster).

In one or more embodiments, S220 may function to re-direct each labeled document or image sample based on whether the document sample is determined to be in-scope or out-of-scope. An in-scope document sample, as referred to herein, preferably relates to a document sample that has been provided a classification label that matches a target category, such as a category provided with document sourcing parameters or an intended category for training a model on a distinct classification task. Conversely, an out-of-scope document sample, as referred to herein, preferably relates to a document sample that has been provided a classification label that does not match a target category for a desired corpus of document samples. Accordingly, S220 may function to create or build a first corpus of labeled document samples that may be in-scope (i.e., an in-scope corpus of labeled training document samples) and a second corpus of labeled document samples that may be out-of-scope (i.e., an out-of-scope corpus of labeled document samples).

It shall be noted that, in some embodiments, one or more portions of one or more corpora of document samples returned by the plurality of external sources of document samples may have a default classification label and/or may be automatically provided a default classification label (via the document-image generator or the like) based on the document sourcing parameters (e.g., seed-derived label/annotation). In such embodiments, S210 may function to update, modify, confirm, and/or augment a default classification label for a given document sample based on the one or more labeling and/or annotation techniques described herein.

### 2.3 Corpus Analyzer: Computing Corpus Metrics

S230, which includes computing one or more metrics for the corpora of document samples, may function to compute one or more efficacy metrics for a given corpus of labeled document samples (e.g., in-scope corpus of labeled training document samples). In a preferred embodiment, the one or more computed efficacy metrics may function to inform a selective routing of a target corpora of document samples one of a plurality of distinct routes, which may include a route for production training (e.g., ready for training), a route for continued corpus development (e.g., not ready for training), and/or the like.

In one implementation, computing the one or more metrics for a target corpus of labeled document data samples includes measuring and/or calculating a diversity metric for the corpus. A diversity metric, as referred to herein, preferably provides a measure indicating a degree or an estimation of heterogeneity among the plurality of distinct document samples defining a target corpus of document samples. In computing the diversity metric for the target corpus of document samples, S230 may function to evaluate a plurality of distinct pairwise defined by distinct pairings of document samples selected from the corpus of document samples. For each distinct pairwise, S230 may function to calculate a reverse of the mean Jaccard Index between a first document sample and a second document sample of each distinct pairwise derived from the target corpus of labeled document samples. In such embodiments, the Jaccard distance may function to compute a dissimilarity or a non-overlap between two distinct document samples and thereby enable a computation of a semantic difference value. Thus, in some embodiments, the Jaccard distance may be converted to a diversity score or used as a diversity score proxy for each evaluated pairwise. Accordingly, an aggregate diversity score or value for a target corpus of document samples may be computed based on taking an average of the diversity scores for all distinct pairwise of the target corpus of labeled document samples.

In another implementation, computing the one or more metrics for a target corpus of labeled document data samples may include performing gap analysis and computing density and/or sparseness values based on computing and clustering hash and/or vector values for each distinct document sample of a target corpus labeled document samples. In this implementation, S230 may function to evaluate the target corpus and compute embedding and/or hash values for all document samples within the target corpus and map the computed embedding or hash values to an n-dimensional space. Accordingly, S230 may function to evaluate each of a density and a sparseness of the mapping of the corpus of hash or embedding values onto the n-dimensional space. In such evaluation, S230 may function to identify over-represented document features based on identifying dense portions of the mapping, which may satisfy or exceed an overrepresentation threshold (e.g., a maximum density of features value). Additionally, S230 may function to identify under-represented document features based identifying sparse portions of the mapping of the vector values, which may satisfy or fall below an underrepresentation threshold (e.g., a minimum density of features value).

In yet another embodiment, S230 may function to identify underrepresented, overrepresented, or missing document or image features using one or more model interpretability modules implementing one or more of local interpretable model-agnostic explanation (LIME) and/or Shapley values (SHAP). Additionally, or alternatively, S230 may function to identify underrepresented, overrepresented, or missing document or image features via an automated inspection of model activations and/or may be inferred using frequency-based analyses of observed features within the corpora of document or image samples.

Additionally, or alternatively, a computation of a density value and/or sparseness value for one or more sections of an n-dimensional mapping of document sample vectors or hashes may function to inform distinct sub-categories of document samples that may be overrepresented or underrepresented in a target corpus of labeled document samples.

### 2.4 Corpus Metrics-Informed Routing

S240, which includes identifying a routing for the one or more corpora of document samples, may function to determine whether to route the one or more corpora of document samples to one of a plurality of distinct machine learning resource stages or production stages including but not limited to, a production machine learning training stage and (reversion to) a training data curation stage based on the corpus metrics derived for the one or more corpora of document samples. In one or more embodiments, a route to the production training stage includes setting the one or more corpora of document samples as training data samples for training one or more machine learning models to be used in production. The reversion to the training data curation stage, in one or more embodiments, includes a continued incremental building of the one or more corpora of document samples to improve corpus metrics and/or mitigate corpus sample deficiencies.

In a first implementation, S240 may function to route the one or more corpora of labeled training document samples to a production training stage based on corpus metrics satisfying one or more corpus efficacy metric thresholds including, but not limited to, a satisfaction of a diversity metric threshold, satisfaction of a gap analysis metric threshold, density metric threshold, sparseness metric threshold, and/or the like (e.g., corpus efficacy metric thresholds). In this first implementation, S240 may function to evaluate the one or more corpus efficacy metrics of the target one or more corpora of documents samples against the one or more corpus efficacy metric thresholds. In such embodiment, if the one or more corpus efficacy metrics satisfy the corpus efficacy metric thresholds, S240 may function to automatically route the one or more corpora of document samples to a production stage, such as a machine learning training stage and/or the like.

In a second implementation, S240 may function to route the one or more training document samples to a training data curation stage based on corpus efficacy metrics failing to satisfy one or more corpus efficacy metric thresholds including, but not limited to, a diversity metric threshold, a gap analysis metric threshold, density metric threshold, sparseness metric threshold, and/or the like. In this second implementation, S240 may function to evaluate the one or more corpus efficacy metrics of the target one or more corpora of documents samples against the one or more corpus efficacy metric thresholds. In such embodiment, if the one or more corpus efficacy metrics do not satisfy the corpus efficacy metric thresholds, S240 may function to automatically route the one or more corpora of document samples to a remedial stage for a continued training data curation of the one or more corpora of document samples. Reverting the one or more corpora of document samples may include initializing a re-seeding stage that may be a part of or cognate to the training data curation stage and may function to produce one or more re-seeded document sourcing parameters that address the one or more deficiencies of the one or more corpora of document samples.

### 2.5 Re-Seeding Generation for Corpus Augmentation

S250, which includes generating one or more re-seeding document sample sourcing parameters, may function to generate one or more new document sourcing parameters (e.g., re-seed sample) for sourcing additional documents samples based on one or more computed efficacy metrics for the one or more corpora of labeled document samples. In a preferred embodiment, S250 may function to derive or estimate a corpus deficiency-type that informs a generation of one or more re-seeding proposals.

In a first implementation, S250 may function to identify an overrepresentation deficiency of the one or more corpora of labeled document samples. In this first implementation, the overrepresentation deficiency may indicate that one or more features of the document samples within the one or more corpora may be overrepresented thereby potentially causing a skew or bias towards the overrepresented feature by a machine learning model trained using the corpora. In some embodiments, an overrepresented feature comprises a document sample sub-type or sub-category. For example, a general or broad domain of a corpus of document samples may be “resume” wherein a plurality of sub-categories or sub-domains may be a variety and/or distinct types of resumes (e.g., marketing, product, engineering, finance resumes, etc.).

In one embodiment, S250 may function to determine or identify an overrepresentation deficiency within the one or more corpora of labeled document samples based on one or more density metrics derived for the one or more corpora. In such embodiment, if the one or more density metric values for (a target feature or target portion of) the one or more corpora satisfy or exceed a density metric threshold (e.g., a maximum density value), S250 may function to identify one or more features or portions of the one or more corpora of labeled document samples as being overrepresented.

In a second implementation, S250 may function to identify an underrepresentation deficiency of the one or more corpora of labeled document samples. In this second implementation, the underrepresentation deficiency may indicate that one or more features of the document samples within the one or more corpora may be underrepresented thereby potentially causing a misclassification of the underrepresented feature by a machine learning trained using the corpora of samples. In some embodiments, an underrepresented feature comprises a document sample sub-type or sub-category.

In one embodiment, S250 may function to determine or identify an underrepresentation deficiency within the one or more corpora of labeled document samples based on one or more sparseness metrics derived for the one or more corpora. In such embodiment, if the one or more sparseness metric values for (a target feature or target portion of) the one or more corpora do not satisfy or fall below a sparseness metric threshold (e.g., a minimum density value or maximum sparseness value), S250 may function to identify one or more features or portions of the one or more corpora of labeled document samples as being underrepresented.

In one variation of the second implementation, S250 may function to determine or identify a feature gap within the one or more corpora of labeled document samples based on one or more of a gap analysis the n-dimensional mapping of the document sample vectors and/or identifying a sparseness metric value for the corpora exceeding a feature gap threshold. A feature gap, as referred to herein, preferably relates to an indication that a feature of a corpus of training data (e.g., corpus of labeled document samples) may be (virtually) non-existent or otherwise, lacking based on a statistically significant threshold or metric for feature presence.

Re-Seeding Generation

Additionally, or alternatively, S250 may function to generate one or more re-seeding sourcing parameters based on one or more of corpus efficacy metrics and corpus deficiencies of the one or more corpora of labeled document samples. That is, in some embodiments, if the corpora of document samples may be routed for a continued building or a re-creation of the corpora, S250 may function to produce re-seeding sourcing parameters that enables the continued creation of the corpora and/or a re-building of the corpora to satisfy one or more training-ready objectives for the corpora.

In one embodiments, if S250 identifies that a diversity metric or the like of the one or more corpora of labeled document samples has not been satisfied, S250 may function to generate one or more re-seed samples or re-seeding sourcing parameters that vary a scope of the sub-type of documents samples that may be sourced through the one or more sample sourcing channels.

In another embodiment, if S250 identifies an underrepresentation deficiency in the one or more corpora of labeled document samples, S250 may function to generate one or more re-seed samples or re-seeding sourcing parameters that may include a discovery, creation, or query terms/parameters for sourcing additional documents in the underrepresented sub-category of document samples or the like. Accordingly, in some embodiments, the re-seeding document sourcing parameters may augment or append to the original seed document sourcing parameters additional terms that explicitly specify the underrepresented sub-category or sub-type of document.

In yet a further embodiment, if S250 identifies an overrepresentation deficiency in the one or more corpora of labeled document samples, S250 may function to generate one or more re-seed samples or re-seeding sourcing parameters that may exclude a discovery, creation, or query terms for sourcing additional document samples except or to the exclusion of the overrepresented sub-category of document samples or the like. Accordingly, in some embodiments, the re-seeding document sourcing parameters may include constraint parameters explicitly exclude the overrepresented sub-category or sub-type of document.

In a preferred embodiment, S250 may function to pass the re-seeding document sourcing parameters to the document-image generator or the like for re-initializing a document samples sourcing process or stage that continues to build the one or more corpora of labeled document samples.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method of curating machine learning training data for improving a predictive accuracy of a machine learning model, the method comprising:
sourcing, via a training data search engine, training data samples based on seeding instructions, wherein the seeding instructions comprise a data sample search query that includes a data sample category parameter;
returning a corpus of unlabeled training data samples based on using the data sample search query to execute a search of one or more data repositories;
assigning one of a plurality of distinct classification labels to each of the training data samples of the corpus of unlabeled training data samples;
computing, by one or more processors, one or more efficacy metrics for an in-scope corpus of labeled training data samples derived from a subset of training data samples of the corpus of unlabeled training data samples that have been assigned one or more of the plurality of distinct classification labels, wherein the one or more efficacy metrics identify whether the in-scope corpus of labeled training data samples is suitable for training a target machine learning model; and
routing, based on the one or more efficacy metrics, the in-scope corpus of labeled training data samples to one of a machine learning training stage for training the target machine learning model and a remedial training data curation stage for adapting the in-scope corpus for training the target machine learning model.

2. The method according to claim 1, wherein:
computing the one or more efficacy metrics for the in-scope corpus of labeled training data samples includes computing a sparseness metric value for one or more regions of an n-dimensional mapping of embedding values of the training data samples of the in-scope corpus;
the method further comprising:
identifying one or more training features of the in-scope corpus that are under-represented based on the sparseness metric value for the one or more regions failing to satisfy a minimum sparseness value threshold,
wherein routing the in-scope corpus of labeled training data samples to the remedial training data curation stage is based on the sparseness metric value for the one or more regions; and
creating, by the one or more processors, re-seeding parameters based on identifying the one or more training features that are under-represented.

3. The method according to claim 2, further comprising:
converting, by the one or more processors, the seeding instructions to re-seeding instructions based on revising the data sample search query with the re-seeding parameters, wherein the re-seeding parameters augments the data sample category parameter with a data sample feature category parameter that informs a directed search for training data samples satisfying the data sample feature category parameter; and
executing a new sourcing, via the training data search engine, for new training data samples based on the re-seeding instructions; and
adapting the in-scope corpus of labeled training data samples with at least part of the new training data samples,
wherein routing the in-scope corpus to the machine learning training stage is based on new sparseness metric values computed for the one or more regions satisfying the minimum sparseness value threshold.

4. The method according to claim 1, wherein:
computing the one or more efficacy metrics for the in-scope corpus of labeled training data samples includes computing a density metric value for one or more regions of an n-dimensional mapping of embedding values of the training data samples of the in-scope corpus;
the method further comprising:
identifying one or more training features of the in-scope corpus that are over-represented based on the density metric value for the one or more regions satisfy a maximum density value threshold,
wherein routing the in-scope corpus of labeled training data samples to the remedial training data curation stage is based on the density metric value for the one or more regions; and
creating re-seeding parameters based on identifying the one or more training features that are over-represented.

5. The method according to claim 4, further comprising:
converting the seeding instructions to re-seeding instructions based on revising the data sample search query with the re-seeding parameters, wherein the re-seeding parameters augments the data sample category parameter with a data sample feature category parameter that informs a directed search for training data samples that do not satisfy the data sample feature category parameter; and
executing a new sourcing, via the training data search engine, for new training data samples based on the re-seeding instructions; and
adapting the in-scope corpus of labeled training data samples with at least part of the new training data samples,
wherein routing the in-scope corpus to the machine learning training stage is based on the adaptation of the in-scope corpus of labeled training data samples.

6. The method according to claim 1, wherein:
computing the one or more efficacy metrics for the in-scope corpus of labeled training data samples includes computing one or more feature gaps of the in-scope corpus of labeled training data samples;
the method further comprising:
identifying one or more training features of the in-scope corpus that are not represented among the labeled training data samples based on the one or more feature gaps,
wherein routing the in-scope corpus of labeled training data samples to the remedial training data curation stage is based on identifying the one or more training features of the in-scope corpus that are not represented; and
creating re-seeding parameters based on the one or more training features that are not represented.

7. The method according to claim 6, further comprising:
converting the seeding instructions to re-seeding instructions based on revising the data sample search query with the re-seeding parameters, wherein the re-seeding parameters augments the data sample category parameter with a data sample feature category parameter that informs a directed search for training data samples that satisfy the data sample feature category parameter; and
executing a new sourcing, via the training data search engine, for new training data samples based on the re-seeding instructions; and
adapting the in-scope corpus of labeled training data samples with at least part of the new training data samples,
wherein routing the in-scope corpus to the machine learning training stage is based on the adaptation of the in-scope corpus of labeled training data samples.

8. The method according to claim 1,
wherein returning the corpus of unlabeled training data samples based on using the data sample search query further includes:
executing a training data sample generation request to one or more data sample generation sources configured to create a plurality of training data samples of the corpus of unlabeled training data samples.

9. The method according to claim 1, further comprises:
defining the in-scope corpus of data samples based on grouping together training data samples having a classification label that satisfies the data sample category parameter of the data sample search query.

10. The method according to claim 2, further comprising:
defining an out-of-scope corpus of data samples based on grouping together training data samples having a classification label that does not satisfy the data sample category parameter of the data sample search query.

11. The method according to claim 10, further comprising:
defining a training corpus of labeled training data samples based on grouping together a sampling of the in-scope corpus of data samples and a sampling of the out-of-scope corpus of data samples.

12. A method of curating machine learning training data for training a machine learning model, the method comprising:
sourcing, via a training data sourcing engine, training data samples based on seeding instructions, wherein the seeding instructions comprise one or more target data samples;
returning a corpus of unlabeled training data samples based on using the one or more target data samples to initialize a machine learning-based generation of each of the unlabeled training data samples;
assigning one of a plurality of distinct classification labels to each training data samples of the corpus of unlabeled training data samples;
computing one or more efficacy metrics for an in-scope corpus of labeled training data samples derived from a subset of the corpus of unlabeled training data samples that have been assigned one or more of the plurality of distinct classification labels, wherein the one or more efficacy metrics identify whether the in-scope corpus of labeled training data samples is suitable for training a target machine learning model; and
routing the in-scope corpus of labeled training data samples to:
a machine learning training stage for training the target machine learning model based on the one or more efficacy metrics satisfying one or more efficacy metric thresholds, or
a remedial training data curation stage for adapting the in-scope corpus for training the target machine learning model based on the one or more efficacy metrics failing to satisfy the one or more efficacy metric thresholds.

13. The method according to claim 12, wherein:
the training data sourcing engine is in operable communication with one or more generative adversarial networks, the one or more generative adversarial network being trained to generate new document samples based on the one or more target data samples comprising one or more document samples, and
the in-scope corpus of labeled training data samples comprises a plurality of labeled document samples for training the target machine learning model.

14. The method according to claim 12, wherein:
the training data sourcing engine is in operable communication with one or more generative adversarial networks, the one or more generative adversarial network being trained to generate new image samples based on the one or more target data samples comprising one or more image samples, and
the in-scope corpus of labeled training data samples comprises a plurality of labeled image samples for training the target machine learning model.

15. A method of curating machine learning training data for a machine learning model, the method comprising:
sourcing, via a web-scale search engine, training data samples based on seeding instructions, wherein the seeding instructions comprise a data sample search query that includes a data sample category parameter;
returning a corpus of unlabeled training data samples based on using the data sample search query to execute a search of one or more web-based data repositories;
converting the corpus of unlabeled training data samples to a corpus of labeled training data samples by assigning one of a plurality of distinct classification labels to each of the unlabeled training data samples;
identifying a corpus deficiency of the corpus of labeled training data samples based on an assessment of one or more feature attributes of the labeled training data samples, wherein the corpus deficiency relates to a defect or lacking in one or more expected features of the labeled training data samples having a likelihood of failing to satisfy a training efficacy threshold for the target machine learning model, when trained using the corpus of labeled training data samples;
computing one or more feature-based category parameters based on the corpus deficiency, wherein the one or more feature-based category parameters, if executed in a new search, likely ameliorate the corpus deficiency;
adapting the seeding instructions based on the one or more feature-based category parameters;
executing a new sourcing, via the training data sourcing engine, for new training data samples based on the adapted seeding instructions;
updating the corpus of labeled training data samples with at least part of the new training data samples; and
initializing a training of the target machine learning model using the corpus of labeled training data samples, as updated, if the corpus deficiency is ameliorated.

16. The method according to claim 15, wherein
identifying the corpus deficiency including computing one or more efficacy metrics including one or more feature density metrics, one or more feature sparseness metrics, or one or more feature gaps of the corpus of labeled training data samples.

17. The method according to claim 15,
wherein the corpus deficiency includes an over-representation deficiency indicating that that one or more features of the labeled training data samples has a density value that satisfies or exceeds a maximum feature density threshold.

18. The method according to claim 15,
wherein the corpus deficiency includes an under-representation deficiency indicating that that one or more features of the labeled training data samples has a density value that does not satisfy a minimum feature density threshold.

19. The method according to claim 15,
wherein the corpus deficiency includes a feature gap deficiency indicating that that one or more expected features the corpus of the labeled training data samples is lacking.
